(19) United States
(12) Patent Application Publication
(10) Pub. No.: US 2026/0176201 A1
(43) Pub. Date: Jun. 25, 2026

(54) GYPSUM BOARDS AND METHODS OF MAKING THEM

(71) Applicant: CERTAINTEED GYPSUM, INC., Malvern, PA (US)

(72) Inventors: Dahlia N. AMATO, Malvern, PA (US); William C. REID, Ambler, PA (US); Serge ADJOUA, Mason, OH (US); Amy M.L. LO, Mississauga (CA); Remi LESPIAT, Devon, PA (US); Sai Anudeep Reddy MADDI, Coatesville, PA (US)

(21) Appl. No.: 19/426,185

(22) Filed: Dec. 19, 2025

Related U.S. Application Data
(60) Provisional application No. 63/737,105, filed on Dec. 20, 2024.

(51) Int. Cl. C04B 24/38; C04B 28/14; C04B 38/00; C04B 103/40; C04B 111/00

(52) U.S. Cl. CPC C04B 24/38; C04B 28/14; C04B 38/0051; C04B 2103/40; C04B 2111/0062

(57) ABSTRACT

A gypsum-based construction material may include a gypsum core. The gypsum core may include a physically modified starch component, and a core bubble median size (D50) of at least about 80 microns and not greater than about 800 microns. The gypsum core may further have a thickness of not greater than about 27 mm, a board weight of at least about 1150 lbs/msf and not greater than about 2600 lbs/msf, a core hardness of at least about 60 N, and a nail pull of at least about 60 lbf.

### CROSS-REFERENCE TO RELATED APPLICATION(S)

This Application claims priority under 35 U.S.C. § 119(e) to U.S. Provisional Patent Application No. 63/737,105, entitled “GYPSUM BOARDS AND METHODS OF MAKING THEM,” filed Dec. 20, 2024, by Dahlia N. AMATO et al., which is assigned to the current assignee hereof and is incorporated herein by reference in its entirety.

### FIELD OF THE DISCLOSURE

The present disclosure relates to gypsum boards with improved physical properties and methods of making the same.

### BACKGROUND

Gypsum building products (e.g., known variously as wallboard, ceiling board, plasterboard, and “drywall”) are panels made of a gypsum core sandwiched between two layers of liner, often paper, on the outside surfaces of the gypsum core. They are widely used as construction materials due to their ease of fabrication, high mechanical strength, low thermal conductivity, resistance to spread of fire, and soundproofing properties. The quality of a gypsum slurry (mainly containing calcium sulfate hemihydrate) into a set body of calcium sulfate dihydrate. To control the properties of gypsum boards, additives are often added to the stucco slurry during the board making process. For example, foaming agents, inorganic compounds, and other additives may be included in the slurry to modulate the physical properties (i.e., surface density, strength, and/or fire resistance properties) of the board. Accordingly, there is a need in the art to find component characteristics, formation methods, and compositions that allow for improved physical properties of gypsum cores in gypsum-based construction materials.

### SUMMARY

According to one aspect, a method of forming a gypsum-based construction material may include providing a stucco-based slurry composition and forming the stucco-based slurry composition into a gypsum-based construction material. The stucco-based slurry composition may include a physically modified starch component at a content of at least about 0.001 wt. % and not greater than about 10 wt. % for a total weight of the stucco-based slurry composition. The gypsum-based construction material formed from the stucco-based slurry composition may include a gypsum core. The gypsum core may have a core bubble median size (D50) of at least about 80 microns and not greater than about 800 microns.

According to another aspect, a method of forming a gypsum-based construction material may include providing a stucco-based slurry composition and forming the stucco-based slurry composition into a gypsum-based construction material. The stucco-based slurry composition may include a physically modified starch component. The physically modified starch component may have a Gel Formation Temperature of not greater than about 50° C. The stucco-based slurry composition may further have a slump size of at least about 5 inches when measured at a temperature of 35° C., and a stiffening time of at least about 10 seconds when measured at a temperature of 35° C.

According to yet another aspect, a method of forming a gypsum-based construction material may include providing a stucco-based slurry composition and forming the stucco-based slurry composition into a gypsum-based construction material. The stucco-based slurry composition may include a physically modified starch component. The gypsum-based construction material formed from the stucco-based slurry composition may include a gypsum core. The gypsum core may have a thickness of not greater than about 27 mm, a board weight of at least about 1150 lbs/msf and not greater than about 2600 lbs/msf, a core hardness of at least about 60 N, and a nail pull of at least about 60 lbf.

According to another aspect, a gypsum-based construction material may be formed from a stucco-based slurry composition. The stucco-based slurry composition may include a physically modified starch component. The gypsum-based construction material formed from the stucco-based slurry composition may include a gypsum core. The gypsum core may have a core bubble median size (D50) of at least about 80 microns and not greater than about 800 microns.

According to still another aspect, a gypsum-based construction material may be formed from a stucco-based slurry composition. The stucco-based slurry composition may include a physically modified starch component. The physically modified starch component may have a Gel Formation Temperature of not greater than about 50° C. The stucco-based slurry composition may further have a slump size of at least about 5 inches when measured at a temperature of 35° C., and a stiffening time of at least about 10 seconds when measured at a temperature of 35° C.

According to another aspect, a gypsum-based construction material may be formed from a stucco-based slurry composition. The stucco-based slurry composition may include a physically modified starch component. The gypsum-based construction material formed from the stucco-based slurry composition may include a gypsum core. The gypsum core may have a thickness of not greater than about 27 mm, a board weight of at least about 1150 lbs/msf and not greater than about 2600 lbs/msf, a core hardness of at least about 60 N, and a nail pull of at least about 60 lbf.

According to still another aspect, a gypsum-based construction material may include a gypsum core. The gypsum core may include a physically modified starch component, and a core bubble median size (D50) of at least about 80 microns and not greater than about 800 microns. The gypsum core may further have a thickness of not greater than about 27 mm, a board weight of at least about 1150 lbs/msf and not greater than about 2600 lbs/msf, a core hardness of at least about 60 N, and a nail pull of at least about 60 lbf.

### BRIEF DESCRIPTION OF THE DRAWINGS

The present disclosure may be better understood, and its numerous features and advantages made apparent to those skilled in the art by referencing the accompanying drawings.

FIG. 1 includes a diagram showing a gypsum-based construction material forming method according to embodiments described herein.

Skilled artisans appreciate that elements in the figures are illustrated for simplicity and clarity and have not necessarily been drawn to scale.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

As used herein, and unless expressly stated to the contrary, “or” refers to an inclusive-or and not to an exclusive-or. For example, a condition A or B is satisfied by any one of the following: A is true (or present), and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

The use of the word “about,” “approximately,” or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the construction products arts.

Embodiments described herein are generally directed to a gypsum-based construction material and methods of forming the same. More particularly, embodiments described herein are directed to a gypsum-based construction material that includes a gypsum core that may include a physically modified starch component and improved physical properties.

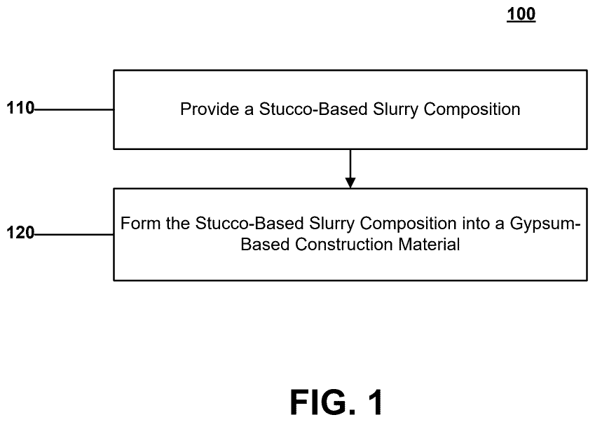

For purposes of illustration, FIG. 1 includes a diagram showing a gypsum-based construction material forming method 100 according to particular embodiments described herein. As shown in FIG. 1, the gypsum-based construction material forming method 100 may include a first step 110 of providing a stucco-based slurry composition, and a second step 120 of forming the stucco-based slurry composition into a gypsum-based construction material that includes a gypsum core.

Referring specifically to the first step 110, according to certain embodiments, the stucco-based slurry composition may include a physically modified starch component.

According to certain embodiments, the physically modified starch component may have a particular Gel Formation Temperature, where the Gel Formation Temperature is defined as the temperature at which the onset of viscosity of the starch component in a 15% solution increases, as measured in a rapid visco analyzer (RVA) at 160 rpm during a 10 minute ramp up step from 25° C. to 90° C. According to particular embodiments, the physically modified starch component may have a Gel Formation Temperature of not greater than about 50° C., such as not greater than about 48° C. or not greater than about 45° C. or not greater than about 43° C. or not greater than about 40° C. or not greater than about 38° C. or not greater than about 35° C. or not greater than about 33° C. or even not greater than about 30° C. According to still other embodiments, the physically modified starch component may have a Gel Formation Temperature of at least about 20° C., such as at least about 21° C. or at least about 22° C. or even at least about 23° C. It will be appreciated that the physically modified starch component may have a Gel Formation Temperature within a range between any of the minimum and maximum values noted above. It will be further appreciated that the physically modified starch component may have a Gel Formation Temperature of any value between any of the minimum and maximum values noted above.

According to certain embodiments, the physically modified starch component may have a particular slump size when the physically modified starch component is incorporated into a stucco-based slurry composition as described herein, where the slump size of the stucco-based slurry composition is measured at 35° C. according to the following procedure: 1) preparing the stucco-based slurry composition as described herein, 2) pouring composition into a 2′ by 4′ cylinder placed on a 12′ by 12′ glass plate, filling the cylinder up to the brim (ensure that the cylinder is not overflowing by using a knife to remove any extra in case the slurry overflows), 3) immediately after filling the cylinder, lifting the cylinder straight up, perpendicularly to the plate (time taken for this step should be no greater than 2 seconds) 4) immediately use a knife to draw a line on the full length of the slurry and observe if the slurry on both sides of the line stays apart, 5) repeat using a knife to draw such a line after every 5 seconds only reducing to every second when the slurry is close to staying apart (be sure to clean the knife in between cuts using a paper), 6) record the time at which a line first stays entirely apart as the stiffening time, 7) at the stiffening time, measure 4 diameters of the slurry on the plate, average them, and record them as the slump size. Keep the slurry sample on the plate; this will be used to measure slump of slurry. According to particular embodiments, the physically modified starch component may have a slump size of not greater than about 13 inches, such as not greater than about 12 inches or not greater than about 11 inches or even not greater than about 10 inches. According to still other embodiments, the physically modified starch component may have a slump size of at least about 5 inches, such as at least about 6 inches or at least about 7 inches or even at least about 8 inches. It will be appreciated that the physically modified starch component may have a slump size within a range between any of the minimum and maximum values noted above. It will be further appreciated that the physically modified starch component may have a slump size of any value between any of the minimum and maximum values noted above.

According to certain embodiments, the physically modified starch component may have a particular Max Viscosity Gel Temperature, where the Max Viscosity Gel Temperature is defined as the gel temperature of the starch component in a 15% solution at its maximum viscosity as measured in a rapid visco analyzer (RVA) while being heated from 25° C. to 90° C. For example, the physically modified starch component may have a Max Viscosity Gel Temperature of not greater than about 50° C., such as not greater than about 49° C. or not greater than about 48° C. or not greater than about 47° C. or not greater than about 46° C. or not greater than about 45° C. or not greater than about 44° C. or not greater than about 43° C. or not greater than about 42° C. or not greater than about 41° C. or not greater than about 40° C. or not greater than about 39° C. or not greater than about 38° C. or not greater than about 37° C. or not greater than about 36° C. or even not greater than about 35° C. According to still other embodiments, the physically modified starch component may have a Max Viscosity Gel Temperature of at least about 20° C., such as at least about 21° C. or at least about 22° C. or at least about 23° C. or at least about 24° C. or at least about 25° C. or at least about 26° C. or at least about 27° C. or at least about 28° C. or at least about 29° C. or even at least about 30° C. It will be appreciated that the physically modified starch component may have a Max Viscosity Gel Temperature within a range between any of the minimum and maximum values noted above. It will be further appreciated that the physically modified starch component may have a Max Viscosity Gel Temperature of any value between any of the minimum and maximum values noted above.

According to certain embodiments, the physically modified starch component may have a particular 2000 CPS Gel Temperature, where the 2000 CPS Gel Temperature is defined as the temperature of the starch component in a 15% solution when it reaches 2000 cps as measured in a rapid visco analyzer (RVA) while being heated from 25° C. to 90° C. For example, the physically modified starch component may have a 2000 CPS Gel Temperature of not greater than about 90° C., such as not greater than about 88° C. or not greater than about 85° C. or not greater than about 83° C. or not greater than about 80° C. or not greater than about 78° C. or not greater than about 75° C. or not greater than about 73° C. or not greater than about 70° C. or not greater than about 68° C. or not greater than about 65° C. or not greater than about 63° C. or not greater than about 60° C. or not greater than about 58° C. or not greater than about 55° C. or not greater than about 53° C. or even not greater than about 50° C. According to still other embodiments, the physically modified starch component may have a 2000 CPS Gel Temperature of at least about 25° C., such as at least about 28° C. or at least about 30° C. or at least about 33° C. or at least about 35° C. or at least about 38° C. or at least about 40° C. or at least about 43° C. or even at least about 45° C. It will be appreciated that the physically modified starch component may have a 2000 CPS Gel Temperature within a range between any of the minimum and maximum values noted above. It will be further appreciated that the physically modified starch component may have a 2000 CPS Gel Temperature of any value between any of the minimum and maximum values noted above.

According to certain embodiments, the physically modified starch component may have a particular Peak Viscosity, where the Peak Viscosity is defined as the maximum viscosity of the starch component in a 15% solution at the Gel Formation Temperature as measured in a rapid visco analyzer (RVA) while being heated from 25° C. to 90° C. For example, the physically modified starch component may have a Peak Viscosity of at least about 1000 cps, such as at least about 1250 cps or at least about 1500 cps or at least about 1750 cps or at least about 2000 cps or at least about 2500 cps or at least about 3000 cps or at least about 3500 cps or at least about 4000 cps or at least about 4500 cps or even at least about 5000 cps. According to still other embodiments, the physically modified starch component may have a Peak Viscosity of not greater than about 15000 cps, such as not greater than about 14000 cps or not greater than about 13000 cps or not greater than about 12000 cps or not greater than about 11000 cps or not greater than about 10000 cps or not greater than about 9000 cps or not greater than about 8000 cps or even not greater than about 7000 cps. It will be appreciated that the physically modified starch component may have a Peak Viscosity within a range between any of the minimum and maximum values noted above. It will be further appreciated that the physically modified starch component may have a Peak Viscosity of any value between any of the minimum and maximum values noted above.

According to certain embodiments, the physically modified starch component may have a particular Final Viscosity, where the Final Viscosity is defined as the viscosity of the starch component in a 15% solution as measured in a rapid visco analyzer (RVQ) when it cools to 30° C. after having reached the Gel Formation Temperature as measured in a rapid visco analyzer (RVA) while being heated from 25° C. to 90° C. For example, the physically modified starch component may have a Final Viscosity of at least about 1000 cps, such as at least about 1250 cps or at least about 1500 cps or at least about 1750 cps or at least about 2000 cps or at least about 2500 cps or at least about 3000 cps or at least about 3500 cps or even at least about 4000 cps. According to still other embodiments, the physically modified starch component may have a Final Viscosity of not greater than about 8000 cps, such as not greater than about 7500 cps or not greater than about 7000 cps or not greater than about 6500 cps or not greater than about 6000 cps or not greater than about 5500 cps or even not greater than about 5000 cps. It will be appreciated that the physically modified starch component may have a Final Viscosity within a range between any of the minimum and maximum values noted above. It will be further appreciated that the physically modified starch component may have a Final Viscosity of any value between any of the minimum and maximum values noted above.

According to yet other embodiments, the physically modified starch component may have a particular Carr index, where the Carr index (CI) is defined by the equation: CI [%]=(1−(Loose Density/Packed Density))*100. According to a particular embodiments, the physically modified starch component may have a Carr index of at least about 0.1, such as, at least about 0.5 or at least about 1.0 or at least about 2.5 or at least about 5.0 or at least about 7.5 or even at least about 10.0. According to still other embodiments, the physically modified starch component may have a Carr index of not greater than about 20, such as, not greater than about 19 or not greater than about 18 or not greater than about 17 or not greater than about 16 or even not greater than about 15. It will be appreciated that the physically modified starch component may have a Carr index within a range between any of the minimum and maximum values noted above. It will be further appreciated that the physically modified starch component may have a Carr index of any value between any of the minimum and maximum values noted above.

According to certain embodiments, the physically modified starch component may be defined as any starch component or material that has undergone a physical modification of the morphology or three dimensional structure of the starch component by way of a physical factor, such as, for example, milling, moisture treatment, temperature treatment, pressure treatment, radiation treatment, pulse-electric field treatment, ultrasonic wave treatment, or any combination thereof. According to certain embodiment, the physically modified starch component may be a milled starch component, a moisture treated starch component, a temperature treated starch component, a pressure treated starch component, a radiation treated starch component, a pulse-electric field treated starch component, an ultrasonic wave treated starch component, or any combination thereof.

According to yet other embodiments, the physically modified starch component may include a non-acid modified starch. According to still other embodiments, the physically modified starch component may consist essentially of a non-acid modified starch. According still other embodiments, the physically modified starch component may be a non-acid modified starch.

According to still other embodiments, the physically modified starch component may include a non-chemically modified starch. According to still other embodiments, the physically modified starch component may consist essentially of a non-chemically modified starch.

According to still other embodiments, the physically modified starch component may be a non-chemically modified starch.

According to yet other embodiments, the physically modified starch component may include a natural starch, a corn starch, a sorghum starch, a wheat starch, a tapioca starch, a rice starch, a pea starch, a potato starch, a maize starch, or any combination thereof. According to still other embodiments, the starch component may consist essentially of a natural starch, a corn starch, a sorghum starch, a wheat starch, a tapioca starch, a rice starch, a pea starch, a potato starch, a maize starch, or any combination thereof.

According to still other embodiments, the physically modified starch may have a particular d50 particle size distribution. For example, the physically modified starch may have a d50 particle size distribution of at least about 100 microns, such as, at least about 105 microns or at least about 110 microns or at least about 115 microns or at least about 120 microns or at least about 125 microns or at least about 130 microns or at least about 135 microns or at least about 140 microns or at least about 145 microns or at least about 150 microns or at least about 155 microns or even at least about 160 microns. It will be appreciated that the d50 particle size distribution of the physically modified starch component may be within a range between any of the values noted above. It will be further appreciated that the d50 particle size distribution of the physically modified starch component may be any value between any of the values noted above.

According to still other embodiments, the physically modified starch may have a particular d90 particle size distribution. For example, the physically modified starch may have a d90 particle size distribution of at least about 250 microns, such as, at least about 255 microns or at least about 260 microns or at least about 265 microns or at least about 270 microns or at least about 275 microns or even at least about 280 microns. It will be appreciated that the d90 particle size distribution of the physically modified starch component may be within a range between any of the values noted above. It will be further appreciated that the d90 particle size distribution of the physically modified starch component may be any value between any of the values noted above.

According to certain embodiments, the stucco-based slurry composition may include a physically modified starch component at a particular content, where the physically modified starch component content is equal to the content of the physically modified starch component in the stucco-based slurry composition in weight percent (wt. %) for a total weight of the stucco-based slurry composition. For example, the stucco-based slurry composition may include a physically modified starch component content of at least about 0.001 wt. % for a total weight of the stucco-based slurry composition, such as, at least about 0.01 wt. % or at least about 0.1 wt. % or at least about 0.2 wt. % or at least about 0.25 wt. % or at least about 0.30 wt. % or at least about 0.35 wt. % or at least about 0.40 wt. % or even at least about 0.45 wt. %. According to still other embodiments, the stucco-based slurry composition may include a physically modified starch component content of not greater than about 10.0 wt. % for a total weight of the stucco-based slurry composition, such as, not greater than about 9.5 wt. % or not greater than about 9.0 wt. % or not greater than about 8.5 wt. % or not greater than about 8.0 wt. % or not greater than about 7.5 wt. % or not greater than about 7.0 wt. % or not greater than about 6.5 wt. % or not greater than about 6.0 wt. % or not greater than about 5.5 wt. % or not greater than about 5.0 wt. % or not greater than about 4.5 wt. % or not greater than about 4.0 wt. % or not greater than about 3.5 wt. % or not greater than about 3.0 wt. % or not greater than about 2.5 wt. % or not greater than about 2.0 wt. % or not greater than about 1.5 wt. % or not greater than about 1.4 wt. % or not greater than about 1.3 wt. % or not greater than about 1.2 wt. % or not greater than about 1.1 wt. % or not greater than about 1.0 wt. % or not greater than about 0.9 wt. % or not greater than about 0.8 wt. % or not greater than about 0.7 wt. % or even not greater than about 0.6 wt. %. It will be appreciated that the physically modified starch component content in the stucco-based slurry composition may be within a range between any of the minimum and maximum values noted above. It will be further appreciated that the physically modified starch component content in the stucco-based slurry composition may be any value between any of the minimum and maximum values noted above.

According to certain embodiments, the physically modified starch component may have a particular stiffening time when the physically modified starch component is incorporated into a stucco-based slurry composition as described herein, where the stiffening time is defined as stiffening time for the component, where the stiffening time of the stucco-based slurry composition is measured at 35° C. according to the following procedure: 1) preparing the stucco-based slurry composition as described herein, 2) pouring composition into a 2′ by 4′ cylinder placed on a 12′ by 12′ glass plate, filling the cylinder up to the brim (ensure that the cylinder is not overflowing by using a knife to remove any extra in case the slurry overflows), 3) immediately after filling the cylinder, lifting the cylinder straight up, perpendicularly to the plate (time taken for this step should be no greater than 2 seconds) 4) immediately use a knife to draw a line on the full length of the slurry and observe if the slurry on both sides of the line stays apart, 5) repeat using a knife to draw such a line after every 5 seconds only reducing to every second when the slurry is close to staying apart (be sure to clean the knife in between cuts using a paper), 6) record the time at which a line first stays entirely apart as the stiffening times. According to particular embodiments, the physically modified starch component may have a stiffening time of not greater than about 400 seconds, such as not greater than about 375 seconds or not greater than about 350 seconds or not greater than about 325 seconds or not greater than about 300 seconds or not greater than about 275 seconds or not greater than about 250 seconds or not greater than about 225 seconds or not greater than about 200 seconds or not greater than about 175 second or even not greater than about 150 seconds. According to still other embodiments, the physically modified starch component may have a stiffening time of at least about 10 seconds, such as at least about 25 seconds or at least about 50 seconds or at least about 75 seconds or at least about 100 seconds or even at least about 125 seconds. It will be appreciated that the physically modified starch component may have a stiffening time within a range between any of the minimum and maximum values noted above. It will be further appreciated that the physically modified starch component may have a stiffening time of any value between any of the minimum and maximum values noted above.

According to certain embodiments, the stucco-based slurry composition may further include a surfactant. According to still other embodiments, the surfactant may include an alkyl ether sulfate, an ethoxylated surfactant, a lauryl surfactant, an alcohol, or any combination thereof. According to yet other embodiments, the surfactant may consist essentially of an alkyl ether sulfate, an ethoxylated surfactant, a lauryl surfactant, an alcohol, or any combination thereof.

According to still other embodiments, the stucco-based slurry composition may include a particular surfactant content where the surfactant content is equal to the content of the surfactant in the stucco-based slurry composition in weight percent (wt. %) for a total weight of the stucco-based slurry composition. For example, the stucco-based slurry composition may include a surfactant content of at least about 0.01 wt. % for a total weight of the stucco-based slurry composition, such as, at least about 0.1 wt. % or at least about 0.15 wt. % or at least about 0.20 wt. % or at least about 0.25 wt. % or at least about 0.30 wt. % or at least about 0.35 wt. % or at least about 0.40 wt. % or even at least about 0.45 wt. %. According to still other embodiments, the stucco-based slurry composition may include a surfactant content of not greater than about 1.0 wt. % for a total weight of the stucco-based slurry composition, such as, not greater than about 0.95 wt. % or not greater than about 0.90 wt. % or not greater than about 0.85 wt. % or not greater than about 0.80 wt. % or not greater than about 0.75 wt. % or not greater than about 0.70 wt. % or not greater than about 0.65 wt. % or not greater than about 0.60 wt. % or even not greater than about 0.55 wt. %. It will be appreciated that the surfactant content in the stucco-based slurry composition may be within a range between any of the minimum and maximum values noted above. It will be further appreciated that the surfactant content in the stucco-based slurry composition may be any value between any of the minimum and maximum values noted above.

According to yet other embodiments, the stucco-based slurry composition may further include a stucco component. According to certain embodiments, the stucco component may include synthetic stucco, natural stucco, recycled stucco, or any combination thereof. According to still other embodiments, the stucco component may consist essentially of synthetic stucco, natural stucco, recycled stucco, or any combination thereof. According to yet other embodiments, the stucco component may be synthetic stucco. According to still other embodiments, the stucco component may be natural stucco. According to other embodiments, the stucco component may be recycled stucco.

According to still other embodiments, the stucco-based slurry composition may include a particular stucco component content, where the stucco component content is equal to the content of the stucco component in the stucco-based slurry composition in weight percent (wt. %) for a total weight of the stucco-based slurry composition. For example, the stucco-based slurry composition may include a stucco component content of at least about 10 wt. % for a total weight of the stucco-based slurry composition, such as, at least about 15 wt. % or at least about 20 wt. % or at least about 25 wt. % or at least about 30 wt. % or at least about 35 wt. % or at least about 40 wt. % or even at least about 45 wt. %. According to still other embodiments, the stucco-based slurry composition may include a stucco component content of not greater than about 95 wt. % for a total weight of the stucco-based slurry composition, such as, not greater than about 90 wt. % or not greater than about 85 wt. % or not greater than about 80 wt. % or not greater than about 75 wt. % or not greater than about 70 wt. % or not greater than about 65 wt. % or not greater than about 60 wt. % or even not greater than about 55 wt. %. It will be appreciated that the stucco component content in the stucco-based slurry composition may be within a range between any of the minimum and maximum values noted above. It will be further appreciated that the stucco component content in the stucco-based slurry composition may be any value between any of the minimum and maximum values noted above.

According to yet other embodiments, the stucco-based slurry composition may further include a reinforcement component. According to certain embodiments, the reinforcement component may include glass fibers. According to still other embodiments, the reinforcement component may consist essentially of glass fibers.

According to still other embodiments, the stucco-based slurry composition may include a particular reinforcement component content, where the reinforcement component content is equal to the content of the reinforcement component in the stucco-based slurry composition in weight percent (wt. %) relative to the total weight of the stucco component in the stucco-based slurry composition. For example, the stucco-based slurry composition may include a reinforcement component content of at least about 0.01 wt. % relative to the total weight of the stucco component in the stucco-based slurry composition, such as, at least about 0.05 wt. % or at least about 0.1 wt. % or at least about 0.5 wt. % or at least about 1.0 wt. % or at least about 1.5 wt. % or at least about 2.0 wt. % or even at least about 2.5 wt. %. According to still other embodiments, the stucco-based slurry composition may include a reinforcement component content of not greater than about 10 wt. % for a total weight of the stucco-based slurry composition, such as, not greater than about 9.5 wt. % or not greater than about 8.0 wt. % or not greater than about 8.5 wt. % or not greater than about 8.0 wt. % or not greater than about 7.5 wt. % or not greater than about 7.0 wt. % or not greater than about 6.5 wt. % or not greater than about 6.0 wt. % or even not greater than about 5.5 wt. %. It will be appreciated that the reinforcement component content in the stucco-based slurry composition may be within a range between any of the minimum and maximum values noted above. It will be further appreciated that the reinforcement component content in the stucco-based slurry composition may be any value between any of the minimum and maximum values noted above.

According to yet other embodiments, the stucco-based slurry composition may further include an accelerator component. According to certain embodiments, the accelerator component may include a heat-resistant gypsum accelerator. According to still other embodiments, the accelerator component may consist essentially of a heat-resistant gypsum accelerator. According to still other embodiments, the heat-resistant gypsum accelerator may be in a liquid form. According to yet other embodiments, the heat-resistant gypsum accelerator may be in a solid form.

According to still other embodiments, the stucco-based slurry composition may include a particular accelerator component content, where the accelerator component content is equal to the content of the accelerator component in the stucco-based slurry composition in weight percent (wt. %) relative to the total weight of the stucco component in the stucco-based slurry composition. For example, the stucco-based slurry composition may include an accelerator component content of at least about 0.1 wt. % relative to the total weight of the stucco component in the stucco-based slurry composition, such as, at least about 0.25 wt. % or at least about 0.5 wt. % or at least about 0.75 wt. % or at least about 1.0 wt. % or at least about 1.5 wt. % or even at least about 2.0 wt. %. According to still other embodiments, the stucco-based slurry composition may include an accelerator component content of not greater than about 5.0 wt. % for a total weight of the stucco-based slurry composition, such as, not greater than about 4.5 wt. % or not greater than about 4.0 wt. % or not greater than about 3.5 wt. % or not greater than about 3.0 wt. % or even not greater than about 2.5 wt. %. It will be appreciated that the accelerator component content in the stucco-based slurry composition may be within a range between any of the minimum and maximum values noted above. It will be further appreciated that the accelerator component content in the stucco-based slurry composition may be any value between any of the minimum and maximum values noted above.

According to yet other embodiments, the stucco-based slurry composition may further include a guar gum component. According to certain embodiments, the guar gum component may include a native guar gum, a chemically modified guar gum, or any combination thereof. According to still other embodiments, the guar gum component may consist essentially of a native guar gum, a chemically modified guar gum, or any combination thereof a heat-resistant gypsum accelerator.

According to yet other embodiments, the stucco-based slurry composition may further include a siloxane component. According to certain embodiments, the siloxane component may include polymethylhydrosiloxane (PMHS), polydimethylsiloxane (PDMS), a silanol containing siloxane, or any combination thereof. According to still other embodiments, the siloxane component may consist essentially of polymethylhydrosiloxane (PMHS), polydimethylsiloxane (PDMS), a silanol containing siloxane, or any combination thereof.

According to still other embodiments, the stucco-based slurry composition may include a particular siloxane component content, where the siloxane component content is equal to the content of the siloxane component in the stucco-based slurry composition in weight percent (wt. %) relative to the total weight of the stucco component in the stucco-based slurry composition. For example, the stucco-based slurry composition may include a siloxane component content of at least about 0.01 wt. % relative to the total weight of the stucco component in the stucco-based slurry composition, such as, at least about 0.1 wt. % or at least about 0.2 wt. % or at least about 0.3 wt. % or at least about 0.4 wt. % or at least about 0.5 wt. % or at least about 0.6 wt. % or even at least about 0.7 wt. %. According to still other embodiments, the stucco-based slurry composition may include an siloxane component content of not greater than about 2.0 wt. % for a total weight of the stucco-based slurry composition, such as, not greater than about 1.9 wt. % or not greater than about 1.8 wt. % or not greater than about 1.7 wt. % or not greater than about 1.6 wt. % or even not greater than about 1.5 wt. %. It will be appreciated that the siloxane component content in the stucco-based slurry composition may be within a range between any of the minimum and maximum values noted above. It will be further appreciated that the siloxane component content in the stucco-based slurry composition may be any value between any of the minimum and maximum values noted above.

According to yet other embodiments, the stucco-based slurry composition may further include a dispersant component. According to certain embodiments, the dispersant component may include polynaphthalene sulfonate, ligno sulfonate, polyaryl ether poly carboxylate, or any combination thereof. According to still other embodiments, the dispersant component may consist essentially of polynaphthalene sulfonate, ligno sulfonate, polyaryl ether poly carboxylate, or any combination thereof.

According to still other embodiments, the stucco-based slurry composition may include a particular dispersant component content, where the dispersant component content is equal to the content of the dispersant component in the stucco-based slurry composition in weight percent (wt. %) relative to the total weight of the stucco component in the stucco-based slurry composition. For example, the stucco-based slurry composition may include a dispersant component content of at least about 0.01 wt. % relative to the total weight of the stucco component in the stucco-based slurry composition, such as, at least about 0.05 wt. % or at least about 0.1 wt. % or at least about 0.2 wt. % or at least about 0.3 wt. % or even at least about 0.4 wt. %. According to still other embodiments, the stucco-based slurry composition may include an dispersant component content of not greater than about 1.0 wt. % for a total weight of the stucco-based slurry composition, such as, not greater than about 0.9 wt. % or not greater than about 0.8 wt. % or not greater than about 0.7 wt. % or not greater than about 0.6 wt. % or even not greater than about 0.5 wt. %. It will be appreciated that the dispersant component content in the stucco-based slurry composition may be within a range between any of the minimum and maximum values noted above. It will be further appreciated that the dispersant component content in the stucco-based slurry composition may be any value between any of the minimum and maximum values noted above.

According to yet other embodiments, the stucco-based slurry composition may further include a water component.

According to still other embodiments, the stucco-based slurry composition may include a particular water component content, where the water component content is equal to the content of the water component in the stucco-based slurry composition in weight percent (wt. %) relative to the total weight of the stucco component in the stucco-based slurry composition. For example, the stucco-based slurry composition may include a water component content of at least about 50 wt. % relative to the total weight of the stucco component in the stucco-based slurry composition, such as, at least about 53 wt. % or at least about 55 wt. % or at least about 58 wt. % or at least about 60 wt. % or even at least about 63 wt. %. According to still other embodiments, the stucco-based slurry composition may include a water component content of not greater than about 90 wt. % for a total weight of the stucco-based slurry composition, such as, not greater than about 88 wt. % or not greater than about 85 wt. % or not greater than about 83 wt. % or not greater than about 80 wt. % or not greater than about 78 wt. % or even not greater than about 75 wt. %. It will be appreciated that the water component content in the stucco-based slurry composition may be within a range between any of the minimum and maximum values noted above. It will be further appreciated that the water component content in the stucco-based slurry composition may be any value between any of the minimum and maximum values noted above.

Referring now to the second step 120 of forming the stucco-based slurry composition into a gypsum-based construction material that include a gypsum core, according to certain embodiments, the aforementioned stucco-based slurry composition or compositions may be deposited to form a gypsum preform of a gypsum-based construction material preform. According to still other embodiments, the gypsum preform can then be dried to make a gypsum core, converting the stucco component into a gypsum component.

According to still other embodiments, the aforementioned stucco-based slurry composition or compositions may be cast to form a gypsum-based construction material such as, a panel, a board, walls, plinths, slabs, columns, sheets, casts, or shafts.

According to still other embodiments, the gypsum core may include a particular gypsum component content, where the gypsum component content is equal to the content of the gypsum component in the gypsum core in weight percent (wt. %) for a total weight of the gypsum core. For example, the gypsum core may include a gypsum component content of at least about 10 wt. % for a total weight of the gypsum core, such as, at least about 15 wt. % or at least about 20 wt. % or at least about 25 wt. % or at least about 30 wt. % or at least about 35 wt. % or at least about 40 wt. % or even at least about 45 wt. %. According to still other embodiments, the gypsum core may include a gypsum component content of not greater than about 95 wt. % for a total weight of the gypsum core, such as, not greater than about 90 wt. % or not greater than about 85 wt. % or not greater than about 80 wt. % or not greater than about 75 wt. % or not greater than about 70 wt. % or not greater than about 65 wt. % or not greater than about 60 wt. % or even not greater than about 55 wt. %. It will be appreciated that the gypsum component content in the gypsum core may be within a range between any of the minimum and maximum values noted above. It will be further appreciated that the gypsum component content in the gypsum core may be any value between any of the minimum and maximum values noted above.

According to yet other embodiments, the gypsum core may further include a reinforcement component. According to certain embodiments, the reinforcement component may include glass fibers. According to still other embodiments, the reinforcement component may consist essentially of glass fibers.

According to still other embodiments, the gypsum core may include a particular reinforcement component content, where the reinforcement component content is equal to the content of the reinforcement component in the gypsum core in weight percent (wt. %) relative to the total weight of the gypsum component in the gypsum core. For example, the gypsum core may include a reinforcement component content of at least about 0.01 wt. % relative to the total weight of the gypsum component in the gypsum core, such as, at least about 0.05 wt. % or at least about 0.1 wt. % or at least about 0.5 wt. % or at least about 1.0 wt. % or at least about 1.5 wt. % or at least about 2.0 wt. % or even at least about 2.5 wt. %. According to still other embodiments, the gypsum core may include a reinforcement component content of not greater than about 10 wt. % for a total weight of the gypsum core, such as, not greater than about 9.5 wt. % or not greater than about 8.0 wt. % or not greater than about 8.5 wt. % or not greater than about 8.0 wt. % or not greater than about 7.5 wt. % or not greater than about 7.0 wt. % or not greater than about 6.5 wt. % or not greater than about 6.0 wt. % or even not greater than about 5.5 wt. %. It will be appreciated that the reinforcement component content in the gypsum core may be within a range between any of the minimum and maximum values noted above. It will be further appreciated that the reinforcement component content in the gypsum core may be any value between any of the minimum and maximum values noted above.

According to still other embodiments, the gypsum core may include a particular dispersant component content, where the dispersant component content is equal to the content of the dispersant component in the gypsum core in weight percent (wt. %) relative to the total weight of the gypsum component in the gypsum core. For example, the gypsum core may include a dispersant component content of at least about 0.01 wt. % relative to the total weight of the gypsum component in the gypsum core, such as, at least about 0.05 wt. % or at least about 0.1 wt. % or at least about 0.15 wt. % or at least about 0.20 wt. % or at least about 0.25 wt. % or at least about 0.30 wt. % or at least about 0.35 wt. % or at least about 0.40 wt. % or even at least about 0.45 wt. %. According to still other embodiments, the gypsum core may include a dispersant component content of not greater than about 1.0 wt. % for a total weight of the gypsum core, such as, not greater than about 0.95 wt. % or not greater than about 0.90 wt. % or not greater than about 0.85 wt. % or not greater than about 0.80 wt. % or not greater than about 0.75 wt. % or not greater than about 0.70 wt. % or not greater than about 0.65 wt. % or not greater than about 0.60 wt. % or even not greater than about 0.55 wt. %. It will be appreciated that the dispersant component content in the gypsum core may be within a range between any of the minimum and maximum values noted above. It will be further appreciated that the dispersant component content in the gypsum core may be any value between any of the minimum and maximum values noted above.

According to still other embodiments, the gypsum core may have a particular starch migration increase, where the starch migration increase is defined as the percent increase in a starch concentration measurement of a 1 mm thick surface layer of the gypsum core (i.e., the a surface layer of the board to a depth of 1 mm from the surface) formed according to embodiments described herein as compared to a starch concentration measurement of a 1 mm thick surface layer of a standard gypsum core (i.e., the a surface layer of the board to a depth of 1 mm from the surface) formed the same way as the gypsum core formed according to embodiments described herein, except using Clinton 240 stock starch—a conventional acid modified starch instead of the physically modified starch component described herein. For purposes of embodiments described herein, starch concentration in a particular layer of material is measured using thermogravimetry analysis of the starch mass loss between 250° C. and 600° C. According to certain embodiments, the gypsum core may have a starch migration increase of at least about 10%, such as, at least about 13% or at least about 15% or at least about 18% or at least about 20% or at least about 23% or at least about 25% or at least about 28% or even at least about 30%. According to still other embodiments, the gypsum core may have a starch migration increase of not greater than about 60%, such as not greater than about 58% or not greater than about 55% or not greater than about 53% or not greater than about 50% or not greater than about 48% or not greater than about 45% or not greater than about 43% or not greater than about 40% or not greater than about 38% or even not greater than about 35%. It will be appreciated that starch migration increase of the gypsum core compared to an acid modified starch may be within a range between any of the minimum and maximum values noted above. It will be further appreciated that the starch migration increase of the gypsum core compared to an acid modified starch may be any value between any of the minimum and maximum values noted above.

According to still other embodiments, the gypsum core may have a particular bubble structure as measured and analyzed according to a gypsum core bubble analysis method described by U.S. patent application Ser. No. 18/481,315, incorporated herein by reference in its entirety.

For purposes of embodiments described herein, core bubble analysis method is conducted according to the following protocol: 1) provide a sample of the gypsum core to be analyzed, 2) form a cut surface that extends across the sample of the gypsum core, 3) capture an image of a region of the cut surface, 4) capture a 2D image of the region of the cut surface, 5) analyze the image to identify bubbles having a diameter of at least 50 micrometers intersecting the cut surface, 6) determine, from the identified bubbles, a set of contacting bubbles each of which is in contact with at least one other bubble, 7) determine, based on the set of contacting bubbles, a measure of bubble contact in the gypsum core based on the identified bubbles in the image; and based on the measure of bubble contact, modifying a first operating parameter of the plurality of operating parameters for forming the porous slurry layer on the receiving surface.

It will be appreciated that the term “bubble” as used herein refers to an open space within the gypsum core that has an identifiable boundary to distinguish the area or volume of the bubble from the gypsum material and from neighboring bubbles. Thus, an open space within the gypsum core may be formed by a single bubble or may be formed by two or more bubbles that are in contact. Bubbles in contact with one another may have started to coalesce but still be identifiable as individual elements based on the shape of the open space within the gypsum. Accordingly, within a gypsum core there may be many bubbles, some of which are in contact with one another.

According to particular embodiments, the gypsum core as described herein may have a particular core bubble median size (D₅₀) as measured using the gypsum core bubble analysis method described herein. It will be appreciated that the core bubble median size (D₅₀) may be defined as the average bubble diameter (i.e., 50% of the bubble diameters are smaller than the value) and is measured according to the gypsum core bubble analysis method described herein. According to certain embodiments, the gypsum core may have a core bubble median size (D₅₀) of at least about 80 microns, such as, at least about 90 microns or at least about 100 microns or at least about 110 microns or at least about 120 microns or at least about 130 microns or at least about 140 microns or at least about 150 microns or at least about 160 microns or at least about 170 microns or at least about 180 microns or at least about 190 microns or at least about 200 microns or at least about 210 microns or at least about 220 microns or at least about 230 microns or at least about 240 microns or at least about 250 microns or at least about 260 microns or at least about 270 microns or at least about 280 microns or at least about 290 microns or even at least about 300 microns. According to still other embodiments, the gypsum core may have a core bubble median size (D₅₀) of not greater than about 800 microns, such as, not greater than about 790 microns or not greater than about 780 microns or not greater than about 770 microns or not greater than about 760 microns or not greater than about 750 microns or not greater than about 740 microns or not greater than about 730 microns or not greater than about 720 microns or not greater than about 710 microns or not greater than about 700 microns or not greater than about 690 microns or not greater than about 680 microns or not greater than about 670 microns or not greater than about 660 microns or not greater than about 650 microns or not greater than about 640 microns or not greater than about 630 microns or not greater than about 620 microns or not greater than about 610 microns or even not greater than about 600 microns. It will be appreciated that the gypsum core may have a core bubble median size (D₅₀) within a range between any of the minimum and maximum values noted above. It will be further appreciated that the gypsum core may have a core bubble median size (D₅₀) of any value between any of the minimum and maximum values noted above.

According to yet other embodiments, the gypsum core may have a particular thickness. For example, the gypsum core may have a thickness of at least about 5.0 mm, such as, at least about 5.5 mm or at least about 6.0 mm or at least about 6.5 mm or at least about 7.0 mm or at least about 7.5 mm or at least about 8.0 mm or at least about 8.5 mm or at least about 9.0 mm or even at least about 9.5 mm. According to still other embodiments, the gypsum core may have a thickness of not greater than about 27.0 mm, such as, 26.0 mm or not greater than about 25.0 mm or not greater than about 24.0 mm or not greater than about 23.0 mm or not greater than about 22.0 mm or not greater than about 21.0 mm or not greater than about 20.0 mm or not greater than about 19.0 mm or not greater than about 18.0 mm or not greater than about 17.0 mm or not greater than about 16.0 mm or not greater than about 15.0 mm or not greater than about 14.0 mm or not greater than about 13.0 mm or not greater than about 12.0 mm or not greater than about 11.0 mm or even not greater than about 10.0 mm. It will be appreciated that the gypsum core may have a thickness within a range between any of the minimum and maximum values noted above. It will be further appreciated that the gypsum core may have a thickness of any value between any of the minimum and maximum values noted above.

According to yet other embodiments, the gypsum core may have a particular surface density. For example, the gypsum core may have a surface density of at least about 1150 lbs./msf, such as, at least about 1200 lbs./msf or at least about 1250 lbs./msf or at least about 1300 lbs./msf or at least about 1350 lbs./msf or at least about 1400 lbs./msf or at least about 1450 lbs./msf or at least about 1500 lbs./msf or at least about 1550 lbs./msf or at least about 1600 lbs./msf or even at least about 1650 lbs./msf. According to still other embodiments, the gypsum core may have a surface density of not greater than about 2600 lbs./msf, such as, not greater than about 2500 lbs./msf or not greater than about 2500 lbs./msf or not greater than about 2450 lbs./msf or not greater than about 2400 lbs./msf or not greater than about 2350 lbs./msf or not greater than about 2300 lbs./msf or not greater than about 2250 lbs./msf or not greater than about 2200 lbs./msf or not greater than about 2150 lbs./msf or not greater than about 2100 lbs./msf or even not greater than about 2050 lbs./msf. It will be appreciated that the gypsum core may have a surface density within a range between any of the minimum and maximum values noted above. It will be further appreciated that the gypsum core may have a surface density of any value between any of the minimum and maximum values noted above.

According to yet other embodiments, the gypsum-based construction material may have a particular thickness. For example, the gypsum-based construction material may have a thickness of at least about 5.0 mm, such as, at least about 6.0 mm or at least about 7.0 mm or at least about 8.0 mm or at least about 9.0 mm or at least about 10.0 mm or at least about 11.0 mm or at least about 12.0 mm or at least about 13.0 mm or at least about 14.0 mm or even at least about 15.0 mm. According to still other embodiments, the gypsum-based construction material may have a thickness of not greater than about 27 mm, such as, not greater than about 26.0 mm or not greater than about 25.0 mm or not greater than about 24.0 mm or not greater than about 23.0 mm or not greater than about 22.0 mm or not greater than about 21.0 mm or even not greater than about 20.0 mm. It will be appreciated that the gypsum-based construction material may have a thickness within a range between any of the minimum and maximum values noted above. It will be further appreciated that the gypsum-based construction material may have a thickness of any value between any of the minimum and maximum values noted above.

According to yet other embodiments, the gypsum-based construction material may have a particular board weight. For example, the gypsum-based construction material may have a board weight of at least about 1150 lbs./msf, such as, at least about 1200 lbs./msf or at least about 1250 lbs./msf or at least about 1300 lbs./msf or at least about 1350 lbs./msf or at least about 1400 lbs./msf or at least about 1450 lbs./msf or at least about 1500 lbs./msf or at least about 1550 lbs./msf or at least about 1600 lbs./msf or even at least about 1650 lbs./msf. According to still other embodiments, the gypsum-based construction material may have a board weight of not greater than about 2600 lbs./msf, such as, 2550 lbs./msf or not greater than about 2500 lbs./msf or not greater than about 2450 lbs./msf or not greater than about 2400 lbs./msf or not greater than about 2350 lbs./msf or not greater than about 2300 lbs./msf or not greater than about 2250 lbs./msf or not greater than about 2200 lbs./msf or not greater than about 2200 lbs./msf or not greater than about 2150 lbs./msf or not greater than about 2100 lbs./msf or not greater than about 2050 lbs./msf or not greater than about 2000 lbs./msf or not greater than about 1950 lbs./msf or not greater than about 1900 lbs./msf or not greater than about 1850 lbs./msf or not greater than about 1800 lbs./msf or not greater than about 1750 lbs./msf or even not greater than about 1700 lbs./msf. It will be appreciated that the gypsum-based construction material may have a board weight within a range between any of the minimum and maximum values noted above. It will be further appreciated that the gypsum-based construction material may have a board weight of any value between any of the minimum and maximum values noted above.

According to yet other embodiments, the gypsum-based construction material may have a particular surface density. For example, the gypsum-based construction material may have a surface density of at least about 1150 lbs./msf, such as, at least about 1200 lbs./msf or at least about 1250 lbs./msf or at least about 1300 lbs./msf or at least about 1350 lbs./msf or at least about 1400 lbs./msf or at least about 1450 lbs./msf or at least about 1500 lbs./msf or at least about 1550 lbs./msf or at least about 1600 lbs./msf or even at least about 1650 lbs./msf. According to still other embodiments, the gypsum-based construction material may have a surface density of not greater than about 2600 lbs./msf, such as, not greater than about 2550 lbs./msf or not greater than about 2500 lbs./msf or not greater than about 2450 lbs./msf or not greater than about 2400 lbs./msf or not greater than about 2350 lbs./msf or not greater than about 2300 lbs./msf or not greater than about 2250 lbs./msf or not greater than about 2200 lbs./msf or not greater than about 2150 lbs./msf or not greater than about 2100 lbs./msf or even not greater than about 2050 lbs./msf. It will be appreciated that the gypsum-based construction material may have a surface density within a range between any of the minimum and maximum values noted above. It will be further appreciated that the gypsum-based construction material may have a surface density of any value between any of the minimum and maximum values noted above.

According to still other embodiments, where the gypsum core has a thickness of not greater than about 27 mm, the gypsum core may have a particular core hardness. For purposes of embodiments described herein, core hardness is measured according to ASTM C473-17. According to particular embodiments, the gypsum core may have a core hardness of at least about 60 N, such as at least about 65 N or at least about 70 N or at least about 75 N or at least about 80 N or at least about 85 N or at least about 90 N or at least about 95 N or at least about 100 N or at least about 105 N or at least about 110 N or at least about 115 N or at least about 120 N or even at least about 125 N. According to still other embodiments, the gypsum core may have a core hardness of not greater than about 150 N, such as, not greater than about 145 N or not greater than about 140 N or not greater than about 135 N or even not greater than about 130 N. It will be appreciated that the gypsum core may have a core hardness within a range between any of the minimum and maximum values noted above. It will be further appreciated that the gypsum core may have a core hardness of any value between any of the minimum and maximum values noted above.

According to still other embodiments, where the gypsum core has a thickness of not greater than about 27 mm, the gypsum core may have a particular nail pull. For purposes of embodiments described herein, nail pull is measured according to ASTM C473-17. According to particular embodiments, the gypsum core may have a nail pull of at least about 60 lbf, such as at least about 65 lbf or at least about 70 lbf or at least about 75 lbf or at least about 80 lbf or at least about 85 lbf or at least about 90 lbf or at least about 95 lbf or even at least about 100 lbf. According to still other embodiments, the gypsum core may have a nail pull of not greater than about 120 lbf, such as, not greater than about 115 lbf or not greater than about 110 lbf or even not greater than about 105 lbf. It will be appreciated that the gypsum core may have a nail pull within a range between any of the minimum and maximum values noted above. It will be further appreciated that the gypsum core may have a nail pull of any value between any of the minimum and maximum values noted above.

According to still other embodiments, the gypsum-based construction material may include a second gypsum layer that may be denser than the gypsum core.

In an embodiment, the gypsum-based construction material can further include at least one liner. The liner may be a particular material that may facilitate improved performance and/or manufacturing of the gypsum-based construction material. In an embodiment, the liner may comprise a paper liner, a glass mat liner, or any combination thereof.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A method of forming a gypsum-based construction material, wherein the method comprises: providing a stucco-based slurry composition comprising a physically modified starch component at a content of at least about 0.001 wt. % and not greater than about 10.0 wt. % for a total weight of the stucco-based slurry composition, and forming the stucco-based slurry composition into a gypsum-based construction material comprising a gypsum core, wherein the gypsum core comprises a core bubble median size (D50) of at least about 80 microns and not greater than about 800 microns.

Embodiment 2. A method of forming a gypsum-based construction material, wherein the method comprises: providing a stucco-based slurry composition comprising a physically modified starch component, and forming the stucco-based slurry composition into a gypsum-based construction material, wherein the physically modified starch component comprises a Gel Formation Temperature of not greater than about 50° C., wherein the stucco-based slurry composition comprises a slump size of at least about 5 inches when measured at a temperature of 35° C., and wherein the stucco-based slurry composition comprises a stiffening time of at least about 10 seconds when measured at a temperature of 35° C.

Embodiment 3. A method of forming a gypsum-based construction material, wherein the method comprises: providing a stucco-based slurry composition comprising a physically modified starch component, and forming the stucco-based slurry composition into a gypsum-based construction material comprising a gypsum core, wherein the gypsum core comprises a thickness of not greater than about 27 mm, wherein the gypsum core comprises a board weight of at least about 1150 lbs/msf and not greater than about 2600 lbs/msf, wherein the gypsum core comprises a core hardness of at least about 60 N, and wherein the gypsum core comprises a nail pull of at least about 60 lbf.

Embodiment 4. A gypsum-based construction material formed from a stucco-based slurry composition, wherein the stucco-based slurry composition comprises a physically modified starch component at a content of at least about 0.001 wt. % and not greater than about 10.0 wt. % for a total weight of the stucco-based slurry composition, wherein the gypsum-based construction material comprising a gypsum core, and wherein the gypsum core comprises a core bubble median size (D50) of at least about 80 microns and not greater than about 800 microns.

Embodiment 5. A gypsum-based construction material formed from a stucco-based slurry composition, wherein the stucco-based slurry composition comprises a physically modified starch component, wherein the physically modified starch component comprises a Gel Formation Temperature of not greater than about 50° C., wherein the stucco-based slurry composition comprises a slump size of at least about 5 inches when measured at a temperature of 35° C., and wherein the stucco-based slurry composition comprises a stiffening time of at least about 10 seconds when measured at a temperature of 35° C.

Embodiment 6. A gypsum-based construction material formed from a stucco-based slurry composition, wherein the stucco-based slurry composition comprises a physically modified starch component, wherein the gypsum-based construction material comprising a gypsum core, wherein the gypsum core comprises a thickness of not greater than about 27 mm, wherein the gypsum core comprises a board weight of at least about 1150 lbs/msf and not greater than about 2600 lbs/msf, wherein the gypsum core comprises a core hardness of at least about 60 N, and wherein the gypsum core comprises a nail pull of at least about 60 lbf.

Embodiment 7. A gypsum-based construction material comprising a gypsum core, wherein the gypsum core comprises: a physically modified starch component, a core bubble median size (D50) of at least about 80 microns and not greater than about 800 microns, a thickness of not greater than about 27 mm, a board weight of at least about 1150 lbs/msf and not greater than about 2600 lbs/msf, a core hardness of at least about 60 N, a nail pull of at least about 60 lbf.

Embodiment 8. The method or gypsum-based construction material of any one of embodiments 1, 2, 3, 4, 5, 6, and 7, wherein the physically modified starch component comprises a Max Viscosity Gel Temperature of not greater than about 50° C.

Embodiment 9. The method or gypsum-based construction material of any one of embodiments 1, 2, 3, 4, 5, 6, and 7, wherein the physically modified starch component comprises a Max Viscosity Gel Temperature of at least about 20° C.

Embodiment 10. The method or gypsum-based construction material of any one of embodiments 1, 2, 3, 4, 5, 6, and 7, wherein the physically modified starch component comprises a 2000 CPS Gel Temperature of not greater than about 90° C.

Embodiment 11. The method or gypsum-based construction material of any one of embodiments 1, 2, 3, 4, 5, 6, and 7, wherein the physically modified starch component comprises a 2000 CPS Gel Temperature of at least about 25° C.

Embodiment 12. The method or gypsum-based construction material of any one of embodiments 1, 2, 3, 4, 5, 6, and 7, wherein the physically modified starch component comprises a Peak Viscosity of at least about 1000 cps.

Embodiment 13. The method or gypsum-based construction material of any one of embodiments 1, 2, 3, 4, 5, 6, and 7, wherein the physically modified starch component comprises a Peak Viscosity of not greater than about 15000 cps.

Embodiment 14. The method or gypsum-based construction material of any one of embodiments 1, 2, 3, 4, 5, 6, and 7, wherein the physically modified starch component comprises a Final Viscosity of at least about 1000 cps.

Embodiment 15. The method or gypsum-based construction material of any one of embodiments 1, 2, 3, 4, 5, 6, and 7, wherein the physically modified starch component comprises a Final Viscosity of not greater than about 8000 cps.

Embodiment 16. The method or gypsum-based construction material of any one of embodiments 1, 2, 3, 4, 5, 6, and 7, wherein the physically modified starch component comprises a non-acid modified starch.

Embodiment 17. The method or gypsum-based construction material of any one of embodiments 1, 2, 3, 4, 5, 6, and 7, wherein the physically modified starch component comprises a non-chemically modified starch.

Embodiment 18. The method or gypsum-based construction material of any one of embodiments 1, 2, 3, 4, 5, 6, and 7, wherein the physically modified starch component comprises a natural starch, such as, a corn starch, a sorghum starch, a wheat starch, a tapioca starch, a rice starch, a pea starch, a potato starch, a maize starch, or any combination thereof.

Embodiment 19. The gypsum-based construction material of embodiment 7, wherein the gypsum-based construction material is formed from a stucco-based slurry composition.

Embodiment 20. The gypsum-based construction material of embodiment 7, wherein the gypsum-based construction material comprises a stucco component.

Embodiment 21. The gypsum-based construction material of embodiment 20, wherein the gypsum-based construction material comprises the physically modified starch component at a content of at least about 0.001 wt. % relative to the content of the stucco component.

Embodiment 22. The gypsum-based construction material of embodiment 20, wherein the gypsum-based construction material comprises the physically modified starch component at a content of not greater than about 10 wt. % relative to the content of the stucco component.

Embodiment 23. The method or gypsum-based construction material of any one of embodiments 2, 3, 5, and 6, wherein the gypsum core comprises a core bubble median size (D₅₀) of at least about 80 microns.

Embodiment 24. The method or gypsum-based construction material of any one of embodiments 2, 3, 5, and 6, wherein the gypsum core comprises a core bubble median size (D₅₀) of not greater than about 800 microns.

Embodiment 25. The method or gypsum-based construction material of any one of embodiments 1, 2, 4, and 5, wherein the gypsum core comprises a thickness of not greater than about 27 mm and wherein the gypsum core comprises a core hardness of at least about 60 N.

Embodiment 26. The method or gypsum-based construction material of any one of embodiments 1, 2, 4, and 5, wherein the gypsum core comprises a thickness of not greater than about 27 mm and wherein the gypsum core comprises a core hardness of not greater than about 150 N.

Embodiment 27. The method or gypsum-based construction material of any one of embodiments 1, 2, 4, and 5, wherein the gypsum core comprises a thickness of not greater than about 27 mm and wherein the gypsum core comprises a nail pull of at least about 60 lbf.

Embodiment 28. The method or gypsum-based construction material of any one of embodiments 1, 2, 4, and 5, wherein the gypsum core comprises a thickness of not greater than about 27 mm and wherein the gypsum core comprises a nail pull of not greater than about 120 lbf.

Embodiment 29. The method or gypsum-based construction material of any one of embodiments 1, 2, 3, 4, 5, 6, and 7, wherein the gypsum core comprises a starch migration increase of at least about 10%.

Embodiment 30. The method or gypsum-based construction material of any one of embodiments 1, 2, 3, 4, 5, 6, and 7, wherein the gypsum core comprises a starch migration increase of not greater than about 60%.

Embodiment 31. The method or gypsum-based construction material of any one of embodiments 1, 2, 3, 4, 5, 6, and 7, wherein the stucco-based slurry composition comprises the surfactant at a content of at least about 0.01 wt. % for a total weight of the stucco-based slurry composition.

Embodiment 32. The method or gypsum-based construction material of any one of embodiments 1, 2, 3, 4, 5, 6, and 7, wherein the stucco-based slurry composition comprises the surfactant at a content of not greater than about 1.0 wt. % for a total weight of the stucco-based slurry composition.

Embodiment 33. The method or gypsum-based construction material of any one of embodiments 1, 2, 3, 4, 5, 6, and 7, wherein the surfactant may include an alkyl ether sulfate, an ethoxylated surfactant, a lauryl surfactant, an alcohol, or any combination thereof.

Embodiment 34. The method or gypsum-based construction material of any one of embodiments 1, 2, 3, 4, 5, 6, and 7, wherein forming the gypsum-based construction material into the gypsum-based construction material comprises: depositing the gypsum-based construction material forming composition to form a gypsum preform of the gypsum-based construction material forming composition, and drying the gypsum prefrom of the gypsum-based construction material forming composition to form a gypsum core.

Embodiment 35. The method or gypsum-based construction material of any one of embodiments 1, 2, 3, 4, 5, 6, and 7, wherein the construction material has a thickness of at least 5.0 mm.

Embodiment 36. The method or gypsum-based construction material of any one of embodiments 1, 2, 3, 4, 5, 6, and 7, wherein the construction material has a thickness of less than 27 mm.

Embodiment 37. The method or gypsum-based construction material of any one of embodiments 1, 2, 3, 4, 5, 6, and 7, wherein the construction material has a surface density of at least 1150 lbs./msf.

Embodiment 38. The method or gypsum-based construction material of any one of embodiments 1, 2, 3, 4, 5, 6, and 7, wherein the construction material has a surface density of less than 2600 lbs./msf.

Embodiment 39. The method or gypsum-based construction material of any one of embodiments 1, 2, 3, 4, 5, 6, and 7, wherein the gypsum-based construction material further comprises at least one liner.

Embodiment 40. The gypsum-based construction material or method of embodiment 39, wherein the at least one liner comprises a paper liner, a glass mat liner, or any combination thereof.

Embodiment 41. The method or gypsum-based construction material of any one of embodiments 1, 2, 3, 4, 5, 6, 7, and 19, wherein the stucco-based slurry composition comprises a stucco component.

Embodiment 42. The method or gypsum-based construction material of embodiment 41, wherein the stucco-based slurry composition comprises the stucco component at a content of at least about 10 wt. % for a total weight of the stucco-based slurry composition.

Embodiment 43. The method or gypsum-based construction material of embodiment 41, wherein the stucco-based slurry composition comprises the stucco component at a content of not greater than about 95 wt. % for a total weight of the stucco-based slurry composition.

Embodiment 44. The method or gypsum-based construction material of embodiment 41, wherein the stucco component comprises of synthetic, natural, or recycled stucco or the combination thereof.

Embodiment 45. The method or gypsum-based construction material of embodiment 41, wherein the stucco-based slurry composition comprises a reinforcement component.

Embodiment 46. The method or gypsum-based construction material of embodiment 45, wherein the reinforcement component comprises glass fiber.

Embodiment 47. The method or gypsum-based construction material of embodiment 45, wherein the stucco-based slurry composition comprises a reinforcement content of at least about 0.01 wt. % relative to the content of stucco component.

Embodiment 48. The method or gypsum-based construction material of embodiment 45, wherein the stucco-based slurry composition comprises a reinforcement content of not greater than about 10 wt. % relative to the content of stucco component.

Embodiment 49. The method or gypsum-based construction material of embodiment 41, wherein the stucco-based slurry composition comprises an accelerator component.

Embodiment 50. The method or gypsum-based construction material of embodiment 49, wherein the accelerator component comprises a heat-resistant gypsum accelerator (both in solid and liquid form).

Embodiment 51. The method or gypsum-based construction material of embodiment 49, wherein the stucco-based slurry composition comprises the accelerator component at a content of at least about 0.1 wt. % relative to the content of the stucco component.

Embodiment 52. The method or gypsum-based construction material of embodiment 49, wherein the stucco-based slurry composition comprises the accelerator component at a content of not greater than about 5.0 wt. % relative to the content of the stucco component.

Embodiment 53. The method or gypsum-based construction material of embodiment 41, wherein the stucco-based slurry composition comprises a guar gum component.

Embodiment 54. The method or gypsum-based construction material of embodiment 53, wherein the guar gum component comprises a native guar gum, a chemically modified guar gum, or any combination thereof.

Embodiment 55. The method or gypsum-based construction material of embodiment 41, wherein the stucco-based slurry composition comprises a siloxane.

Embodiment 56. The method or gypsum-based construction material of embodiment 55, wherein the siloxane comprises PMHS, PDMS, a silanol containing siloxane, or any combination thereof.

Embodiment 57. The method or gypsum-based construction material of embodiment 55, wherein the stucco-based slurry composition comprises a siloxane content of at least about 0.01 wt. % relative to the content of the stucco component.

Embodiment 58. The method or gypsum-based construction material of embodiment 55, wherein the stucco-based slurry composition comprises a siloxane content of not greater than about 2.0 wt. % relative to the content of the stucco component.

Embodiment 59. The method or gypsum-based construction material of embodiment 41, wherein the stucco-based slurry composition comprises a dispersant.

Embodiment 60. The method or gypsum-based construction material of embodiment 59, wherein the precursor dispersant component comprises polynaphthalene sulfonate, ligno sulfonate, polyaryl ether poly carboxylate or any combination thereof.

Embodiment 61. The method or gypsum-based construction material of embodiment 59, wherein the stucco-based slurry composition comprises the dispersant component at a content of at least about 0.01 wt. % relative to the content of the stucco component.

Embodiment 62. The method or gypsum-based construction material of embodiment 59, wherein the stucco-based slurry composition comprises the dispersant component at a content of not greater than about 1 wt. % relative to the content of the precursor stucco component.

Embodiment 63. The method or gypsum-based construction material of embodiment 41, wherein the stucco-based slurry composition comprises a water component.

Embodiment 64. The method or gypsum-based construction material of embodiment 63, wherein the stucco-based slurry composition comprises the water component at a content at least 50% relative to the content of the stucco component.

Embodiment 65. The method or gypsum-based construction material of embodiment 63, wherein the stucco-based slurry composition comprises the water component at a content of not greater than 90% relative to the content of the stucco component.

Embodiment 66. The method or gypsum-based construction material of any one of embodiments 1, 2, 3, 4, 5, 6, and 7, wherein the physically modified starch has a Carr index of at least about 0.1.

Embodiment 67. The method or gypsum-based construction material of any one of embodiments 1, 2, 3, 4, 5, 6, and 7, wherein the physically modified starch has a Carr index of not greater than about 20.

### EXAMPLES

### Example 1

The following non-limiting examples illustrate the embodiments described herein.

Sample S1 was prepared by mixing a stucco-based slurry composition with 17 g of 1% retardant in water solution (0.03 wt. % retardant based on the weight of the stucco), 400 g water (80 wt. % based on the weight of the stucco), 4.5 g physically modified starch (0.9 wt. % based on the weight of the stucco), 2 g of a gypsum accelerator (0.4 wt. % based on the weight of the stucco), 2 g of fluidizer (0.4 wt. % based on the weight of the stucco). Surfactant solution (1 wt. %) was then injected into the stucco-based slurry composition to achieve a ½ inches thick board with board surface density target at 1500 lbs/msf. The stucco-based slurry was allowed to set and dried to remove excess water, forming the final gypsum board.

A comparative sample CS1 was prepared by mixing a stucco-based slurry composition with 17 g of 1% retardant in water solution (0.03 wt. % retardant based on the weight of the stucco), 400 g water (80 wt. % based on the weight of the stucco), 4.5 g of Clinton 240 stock starch—a conventional acid modified starch component (0.9 wt. % based on the weight of the stucco), 2 g of a gypsum accelerator (0.4 wt. % based on the weight of the stucco), 2 g of fluidizer (0.4 wt. % based on the weight of the stucco). Surfactant solution (1 wt. %) was then injected into the stucco-based slurry composition to achieve a ½ inches thick board with board surface density target at 1500 lbs/msf. The stucco-based slurry was allowed to set and dried to remove excess water, forming the final gypsum board.

The starch component characteristics for sample S1 and comparative sample CS1, including Gel Formation Temperature, 2000 CPS Gel Temperature, Peak Viscosity and Final Viscosity, were measured as described herein and provided below in Table 1.

TABLE 1
Starch Component Characteristics

| Characteristic | S1 | CS1 |
|---|---|---|
| Gel Formation Temperature (° C.) | 45.6 | 71.4 |
| 2000 CPS Gel Temperature (° C.) | 69.4 | 87.45 |
| Peak Viscosity (CPS) | 10180 | 728 |
| Final Viscosity (CPS) | 5597 | 296 |

The performance characteristics for sample S1 and comparative sample CS1, including Slump Size, Stiffening Time, Bubble Median Size, Nail Pull and Core Hardness, were measured as described herein and provided below in Table 2.

TABLE 2
Performance

| Performance Property | S1 | CS1 |
|---|---|---|
| Slump Size (in) | 12.5 | 13.5 |
| Stiffening Time (sec) | 178 | 204 |
| Bubble Median Size (microns) | 230 | 165 |
| Nail Pull (lbf) | 85 | 85 |
| Core Hardness (N) | 106 | 83 |
| Starch Migration Increase | 39 | N/A |
| (percent increase over CS1) | | |

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A gypsum-based construction material formed from a stucco-based slurry composition,
wherein the stucco-based slurry composition comprises a physically modified starch component at a content of at least about 0.001 wt. % and not greater than about 10.0 wt. % for a total weight of the stucco-based slurry composition,
wherein the gypsum-based construction material comprising a gypsum core, and
wherein the gypsum core comprises a core bubble median size (D50) of at least about 80 microns and not greater than about 800 microns.

2. The gypsum-based construction material of claim 1, wherein the physically modified starch component comprises a Max Viscosity Gel Temperature of at least about 20° C. and not greater than about 50° C.

3. The gypsum-based construction material of claim 1, wherein the physically modified starch component comprises a 2000 CPS Gel Temperature of at least about 25° C. and not greater than about 90° C.

4. The gypsum-based construction material of claim 1, wherein the physically modified starch component comprises a Peak Viscosity of at least about 1000 cps.

5. The gypsum-based construction material of claim 1, wherein the physically modified starch component comprises a non-acid modified starch.

6. The gypsum-based construction material of claim 1, wherein the physically modified starch component comprises a non-chemically modified starch.

7. The gypsum-based construction material of claim 1, wherein the physically modified starch component comprises a natural starch, such as, a corn starch, a sorghum starch, a wheat starch, a tapioca starch, a rice starch, a pea starch, a potato starch, a maize starch, or any combination thereof.

8. The gypsum-based construction material of claim 1, wherein the gypsum core comprises a thickness of not greater than about 27 mm and wherein the gypsum core comprises a core hardness of at least about 60 N.

9. The gypsum-based construction material of claim 1, wherein the gypsum core comprises a thickness of not greater than about 27 mm and wherein the gypsum core comprises a nail pull of at least about 60 lbf.

10. A gypsum-based construction material comprising a gypsum core, wherein the gypsum core comprises:
a physically modified starch component,
a core bubble median size (D50) of at least about 80 microns and not greater than about 800 microns,
a thickness of not greater than about 27 mm,
a board weight of at least about 1150 lbs/msf and not greater than about 2600 lbs/msf,
a core hardness of at least about 60 N,
a nail pull of at least about 60 lbf.

11. The gypsum-based construction material of claim 10, wherein the gypsum-based construction material comprises a stucco component.

12. The gypsum-based construction material of claim 11, wherein the gypsum-based construction material comprises the physically modified starch component at a content of at least about 0.001 wt. % relative to the content of the stucco component.

13. The gypsum-based construction material of claim 11, wherein the gypsum-based construction material comprises the physically modified starch component at a content of not greater than about 10 wt. % relative to the content of the stucco component.

14. The gypsum-based construction material of claim 13, wherein the gypsum core comprises a core bubble median size (D₅₀) of at least about 80 microns.

15. The gypsum-based construction material of claim 14, wherein the gypsum core comprises a core bubble median size (D₅₀) of not greater than about 800 microns.

16. The gypsum-based construction material of claim 11, wherein the gypsum core comprises a starch migration increase of at least about 10%.

17. The gypsum-based construction material of claim 11, wherein the gypsum core comprises a starch migration increase of not greater than about 60%.

18. The gypsum-based construction material of claim 10, wherein the surfactant may include an alkyl ether sulfate, an ethoxylated surfactant, a lauryl surfactant, an alcohol, or any combination thereof.

19. A method of forming a gypsum-based construction material, wherein the method comprises:
providing a stucco-based slurry composition comprising a physically modified starch component, and
forming the stucco-based slurry composition into a gypsum-based construction material,
wherein the physically modified starch component comprises a Gel Formation Temperature of not greater than about 50° C.,
wherein the stucco-based slurry composition comprises a slump size of at least about 5 inches when measured at a temperature of 35° C., and
wherein the stucco-based slurry composition comprises a stiffening time of at least about 10 seconds when measured at a temperature of 35° C.

20. The method of claim 19, wherein forming the gypsum-based construction material into the gypsum-based construction material comprises:
depositing the gypsum-based construction material forming composition to form a gypsum preform of the gypsum-based construction material forming composition, and
drying the gypsum prefrom of the gypsum-based construction material forming composition to form a gypsum core.
